(19) United States
(12) Patent Application Publication
(10) Pub. No.: US 2006/0260559 A1
(43) Pub. Date: Nov. 23, 2006

(54) Multifunctional canine training pad

(75) Inventors: David Earl Fry, Midlothian, TX (US); James Michael Gregory, Mansfield, TX (US); Randall Thomas Krum, Bedford, TX (US); Tony Howard Lewis, Grand Prairie, TX (US); Susan Crawford Pope, Bedford, TX (US)

Correspondence Address: LOCKE LIDDELL & SAPP LLP;ATTN: STACIE COX, 2200 ROSS AVENUE, SUITE 2200, DALLAS, TX, 75201-6776, US

(73) Assignee: The Bramton Company

(21) Appl. No.: 11/133,841

(22) Filed: May 19, 2005

(51) Int. Cl. A01K 1/015

(52) U.S. Cl. 119/526

(57) ABSTRACT

A multifunctional, disposable training pad useful for housebreaking pets, particularly canines, that preferably comprises a moisture-absorbing filler material captured between a permeable top sheet and an impermeable bottom sheet, the bottom sheet having two parallel, releasable adhesive strips, one strip being located proximally to each of two oppositely disposed edges of the pad to facilitate selective attachment to a floor surface or to an adjacent pad, the pad also including an animal attractant composition and optionally including a chew-deterrent composition having a non-deterring scent.

### BACKGROUND OF THE INVENTION

1. Field of the Invention

This invention relates to disposable pads useful for housebreaking animals, especially puppies, and more particularly relates to disposable training pads having one or more attractant scents, means for creating a variable-sized training area, and optionally, a bitter-tasting component having a substantially neutral scent to deter puppies from chewing on the pads.

2. Description of Related Art

The use of disposable pads for housebreaking puppies is well known. Such pads are commercially available and typically comprise an absorbent filler material disposed between a flexible, plastic backing sheet that serves as a moisture barrier and a moisture-permeable, non-woven top sheet. Because the plastic backing sheets tend to slide around on a floor, adhesive pads and strips have previously been used to maintain the pads in a desired location during use. In practice, many users of prior art pads have overlapped two or more pads to increase the effective surface area and thereby reduce the likelihood of accidents arising from “missing the pad.” However, simply overlapping the pads is often ineffective because the pads get moved around before, during or after use, creating gaps or bare spots where leakage occurs.

The use of various materials for modifying the excretory behavior of animals, including dogs, is disclosed in U.S. Pat. No. 5,287,826 and the references identified therein.

The use of scented substances as attractants to induce dogs to eliminate on an animal waste collection pad is disclosed, for example, in U.S. Pat. No. 4,800,677, which further discloses the use of tapes or drawstrings bonded to a backing sheet in alignment with folded-over sections to reinforce the assembly and for use in tying the pad into a bundle for disposal.

The use of a plurality of parallel adhesive strips, each having a peelable plastic film or shielding material, to releasably secure absorbent pads to the floor of a pet cage or carrier is disclosed, for example, in U.S. Pat. No. 5,715,772. The shielding material is preferably attached to the pad so that even after it is peeled back to expose the adhesive surface of the strip, it remains connected to the pad during use and does not require disposal.

The use of a bitter chemical such as quinine to impregnate the surface of a pet marking restraint device and thereby prevent the animal from chewing and tearing at the device is disclosed at U.S. Pat. No. 6,334,408.

Puppy training pads have previously been marketed that have two parallel adhesive strips, with each strip being placed 2.5 inches from one of two opposite edges of the pad. Such pads cannot be easily interconnected to form a training area having a useful surface larger than that of a single pad without excessive overlap that significantly diminishes the available useful surface.

### SUMMARY OF THE INVENTION

The pet training pads of the invention are specially constructed to facilitate attachment to each other to produce a larger effective training surface for pets, especially puppies. Preferably, the subject pads are rectangular, and most preferably square, and comprise two parallel strips of releasable adhesive that are spaced inwardly from each of two oppositely disposed pad edges and extend continuously across the pad. Each strip is preferably spaced inwardly from the nearest parallel edge by a distance that approximates the width of the strip. According to one particularly preferred embodiment of the invention, each adhesive strip is about 0.5 inches wide and is spaced about 0.5 inches inwardly from the nearest edge of the pad. While the precise dimensions are not critical to the invention, the concept of providing parallel, continuous, full-length, releasable adhesive strips spaced inwardly of two opposite pad edges by a distance equaling approximately one strip width is believed to be novel and particularly useful for connecting a plurality of pads to create a larger usable surface while simultaneously releasably attaching each of the pads to an underlying substrate such as a floor surface.

The pet training pads of the invention preferably further comprise a material having a scent that functions as an attractant and increases the tendency of a puppy or other pet to eliminate on the pad. According to one preferred embodiment of the invention, the attractant is in the form of a fine granular or powdered substance that is distributed throughout the absorbent filler material during manufacture, although it will be appreciated upon reading this disclosure that an attractant material can also be incorporated into or coated onto a pad by other similarly effective means such as spraying, and the like.

The pet training pads of the invention optionally further comprise a substance that is distasteful to animals and that can be incorporated into the subject pads to discourage animal users, especially puppies, from chewing on the pads. The distasteful component will preferably not, however, have a scent that deters usage of the pad by the animal.

### BRIEF DESCRIPTION OF THE DRAWINGS

A preferred training pad of the invention is further described and explained in relation to the following drawings wherein:

FIG. 1 is a bottom plan view, partially broken away, of a preferred embodiment of the multifunctional canine training pad of the invention;

FIG. 2 is a cross-sectional elevation view, partially broken away, taken along line 2-2 of FIG. 1;

FIG. 3 is a top plan view of the pad of FIG. 1;

FIG. 4 is a cross-sectional elevation view, partially broken away, depicting the releasable attachment of the pad of FIG. 1 to a floor surface;

FIG. 5 is a simplified diagrammatic bottom plan view of two of the subject multifunctional canine training pads disposed in overlapping relationship, with an adhesive strip of one pad releasably securing it to an adjacent pad;

FIG. 6 is a simplified diagrammatic bottom plan view of three of the subject multifunctional canine training pads releasably joined in a linear array to create a training surface larger than that depicted in FIG. 5;

FIG. 7 is a simplified diagrammatic bottom plan view of three of the subject multifunctional canine training pads releasably joined in an L-shaped array to create a training surface larger than that depicted in FIG. 5;

FIG. 8 is a simplified diagrammatic bottom plan view of four of the subject multifunctional canine training pads releasably joined in a substantially square array to create a training surface larger than that depicted in any of FIGS. 5-7; and

FIG. 9 is a cross-sectional elevation view, partially broken away, taken along line 9-9 of FIG. 5.

### DESCRIPTION OF THE PREFERRED EMBODIMENTS

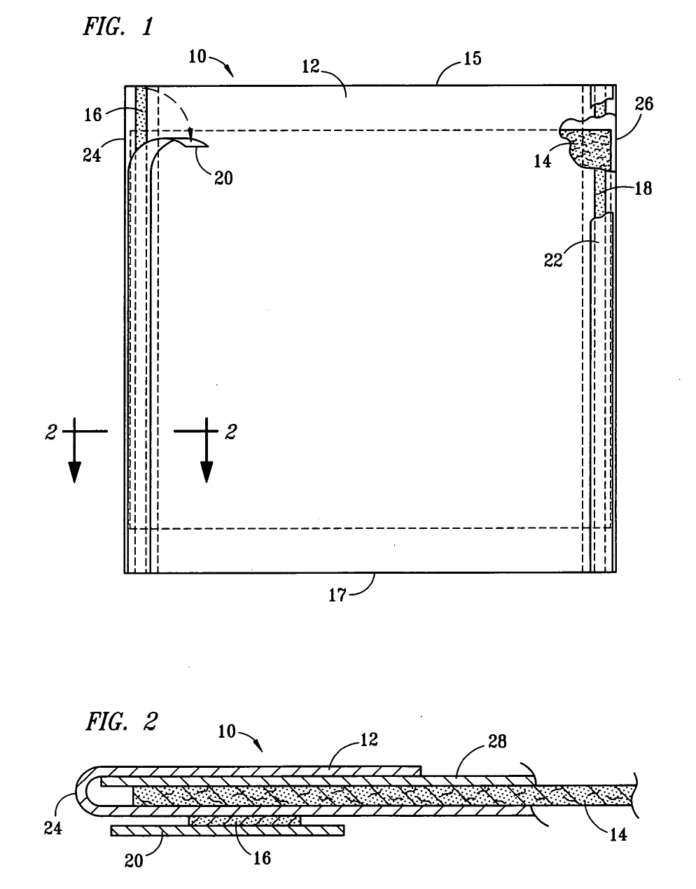

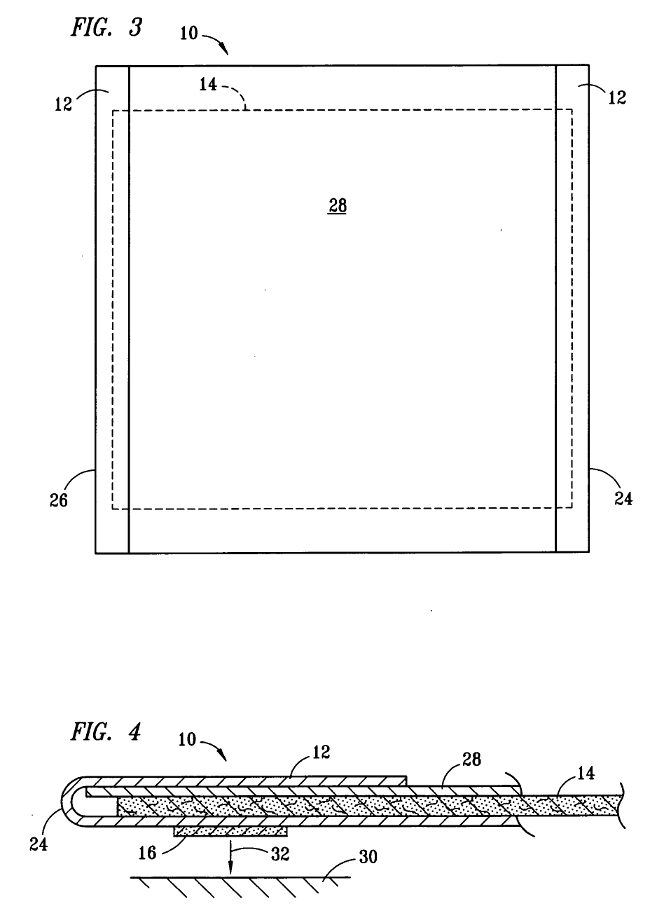

Referring to FIGS. 1 to 4, a preferred embodiment of training pad 10 of the invention comprises a web of moisture absorbing filler material 14 disposed between a moisture permeable top sheet 28 and a moisture impermeable backing sheet 12 that are sealed together around the edges. Moisture absorbing filler material 14 is preferably a cellulosic or polymeric material, and can comprise, for example, a mat of woven or non-woven natural or synthetic fibers, hydrophillic material, and mixtures thereof. Tissue paper and super absorbent polymer (SAP) are illustrative examples of types of filler material 14 suitable for use in the invention. Backing sheet 12, preferably a foldable, lightweight polymeric sheet, that is depicted in the drawings as being folded upwardly and over the side edges of top sheet 28 at sides 24, 26 of training pad 10, and then sealed to the outwardly facing surface of top sheet 28 by heat-sealing, by use of an adhesive, or by any other similarly effective means. It should be appreciated, however, that folding backing sheet 12 upwardly and over the side edges of top sheet 28 at sides 24, 26 is not required for practicing other embodiments of the invention. Top sheet 28 is preferably made of a non-woven fibrous polymeric material that is moisture permeable but resistant to tearing during use. Strips 16, 18 of commercially available releasable adhesive are preferably disposed parallel to sides 24, 26 on the back surface of backing sheet 12 and each is desirably covered with a peel-away release strip 20, 22. Release strips 20, 22 can be made of any suitable material, such as coated paper, and are preferably wider than adhesive strips 16, 18 to facilitate removal.

Although the shape and dimensions of training pad 10 can vary, pads that are rectangular, and most preferably substantially square, are preferred to facilitate attachment to other pads to create larger surfaces. The width of adhesive strips 16, 18 can also vary, with the use of wider strips being generally preferred for use with wider pads. A significant aspect of the present invention is the placement of adhesive strips 16, 18 in relation to side edges 24, 26, respectively, of pad 10. Strips 16, 18 are preferably parallel to each other, with one of strips 16, 18 being disposed proximally to each side edge. Most preferably, each of strips 16, 18 is disposed about one strip width inwardly of the respective side edge of training pad 10. An adhesive strip width and edge spacing of about 0.5 inches each are particularly preferred for use with substantially square training pads 10 having sides ranging, for example, between 22 and 24 inches.

Adhesive strips 16, 18 of training pad 10 function in one of two ways, depending upon whether training pad 10 is used alone or in combination with other such pads to create a training surface having a larger area. If training pad 10 is used alone, both of release strips 20, 22 are peeled away and removed, and adhesive strips 16, 18 are each pressed downwardly against an underlying substrate, typically a non-carpeted floor surface, to releasably attach training pad 10 to the floor in a desired location. FIG. 2 depicts a broken-away side section of training pad 10 prior to the removal of release strip 20 from adhesive strip 16. FIG. 4 depicts the same section of training pad 10 as in FIG. 2, but with release strip 20 removed for releasable attachment of adhesive strip 16 to substrate 30 as indicated by arrow 32.

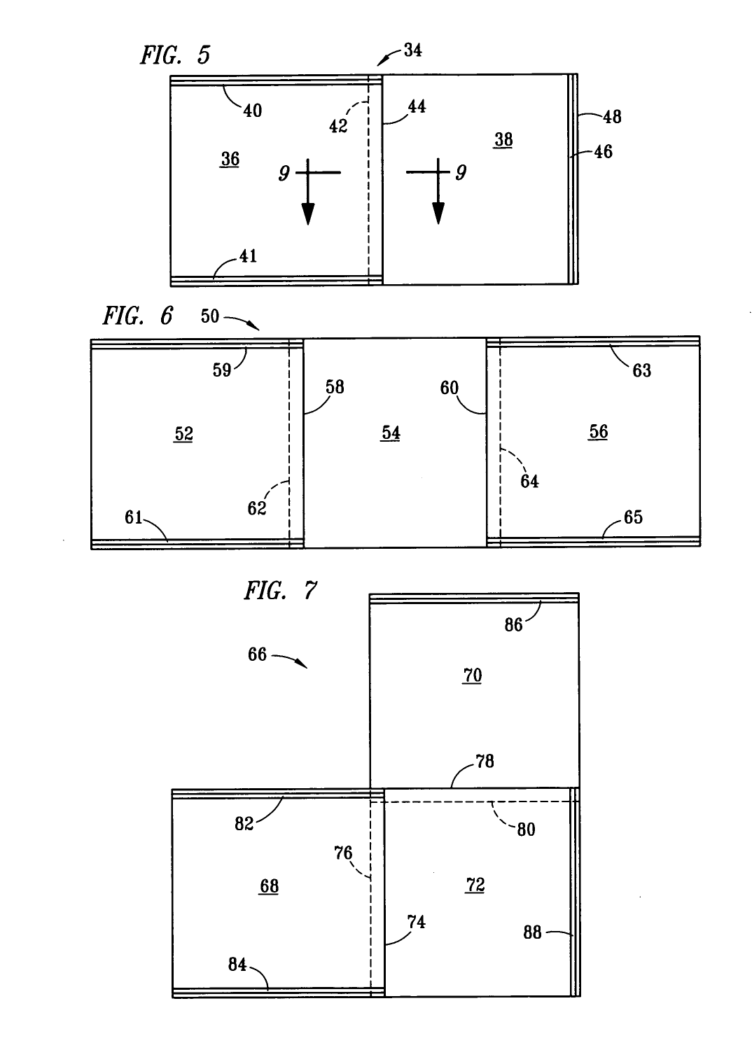

If training pad 10 is to be used in combination with other such pads, as is described in greater detail below in relation to FIGS. 5 to 9, one or both of adhesive strips 16, 18 can be used instead to attach the back side of one pad along an edge of the front side of a different pad. When training pad 10 is used in this manner, and depending upon the number of pads connected to create a larger training surface and upon the configuration of the larger surface, each pad can be releasably attached to both the underlying floor and to an adjacent pad, or, as shown in FIG. 7, to two adjacent pads. Where a training pad 10 is attached to two adjacent pads, the combined training surface will still be attachable to the floor surface using one or more available adhesive strips on the other pads. The type and amount of adhesive used is preferably such that training pads 10 can be attached to a floor surface or to another pad, then subsequently pulled apart and reattached for repositioning or relocation without damage to the pad. The use of a releasable adhesive will also facilitate replacement of a soiled pad within a training surface comprising more than one pad.

FIGS. 5 and 9 depict a bottom plan view of a composite pet housetraining pad 34 comprising two substantially square pet training pads 36, 38 made as described above in relation to training pad 10. As viewed from the bottom, training pad 38 is rotated 90 degrees relative to pad 36 so that edge 42 of pad 38 lies above pad 36 and overlaps edge 44 of pad 36, thereby permitting adhesive strip 43 of pad 38 to be releasably attached to an adjacent portion of the upwardly facing surface of pad 36, as is best seen in FIG. 9. Referring to FIG. 9, adhesive strip 43 provides a continuous seal between pads 36, 38 to prevent fluid leakage between them, and also reduces the likelihood that a puppy, for example, can insert a paw or its nose between edge 42 and edge 44 to pull pads 36, 38 apart. When training pads 36, 38 are aligned and attached to each other in the configuration shown in FIG. 5, adhesive strips 40, 41 of pad 36 and adhesive strip 46 of pad 38 can still be used to releasably attach composite pad 34 to an underlying support surface, thereby reducing the likelihood that composite pad 34 will be unintentionally or accidentally moved.

FIG. 6 depicts a bottom plan view of a composite pet housetraining pad 50 comprising three substantially square pet training pads 52, 54, 56 made as described above in relation to training pad 10. As viewed from the bottom, training pads 52, 54, 56 are linearly aligned and pad 54 is rotated 90 degrees relative to pads 52, 56. Edge 62 of pad 54 lies above pad 52 and overlaps edge 58 of pad 52, thereby permitting one adhesive strip (not visible) of pad 54 to be releasably attached to an adjacent portion of the upwardly facing surface of pad 52. Similarly, edge 64 of pad 54 lies above pad 56 and overlaps edge 60 of pad 56, thereby permitting one adhesive strip (not visible) of pad 54 to be releasably attached to an adjacent portion of the upwardly facing surface of pad 56. When training pads 52, 54, 56 are aligned and attached to each other in the configuration shown in FIG. 6, adhesive strips 59, 61 of pad 52 and adhesive strips 63, 65 of pad 56 can still be used to releasably attach composite pad 50 to an underlying support surface.

FIG. 7 depicts a bottom plan view of a composite pet housetraining pad 66 comprising three substantially square pet training pads 68, 70, 72 made as described above in relation to training pad 10. As viewed from the bottom, training pads 68, 70, 72 are aligned in an angular array and pad 72 is rotated 90 degrees relative to pads 68, 70 so that edge 76 of pad 72 lies above pad 68 and overlaps edge 74 of pad 68, thereby permitting one adhesive strip (not visible) of pad 72 to be releasably attached to an adjacent portion of the upwardly facing surface of pad 68. Similarly, edge 80 of pad 70 lies above pad 72 and overlaps edge 78 of pad 72, thereby permitting one adhesive strip (not visible) of pad 70 to be releasably attached to an adjacent portion of the upwardly facing surface of pad 72. When training pads 68, 70, 72 are oriented and attached to each other in the configuration shown in FIG. 7, adhesive strips 82, 84 of pad 68, adhesive strip 86 of pad 70 and adhesive strip 88 of pad 72 can still be used to releasably attach composite pad 66 to an underlying support surface.

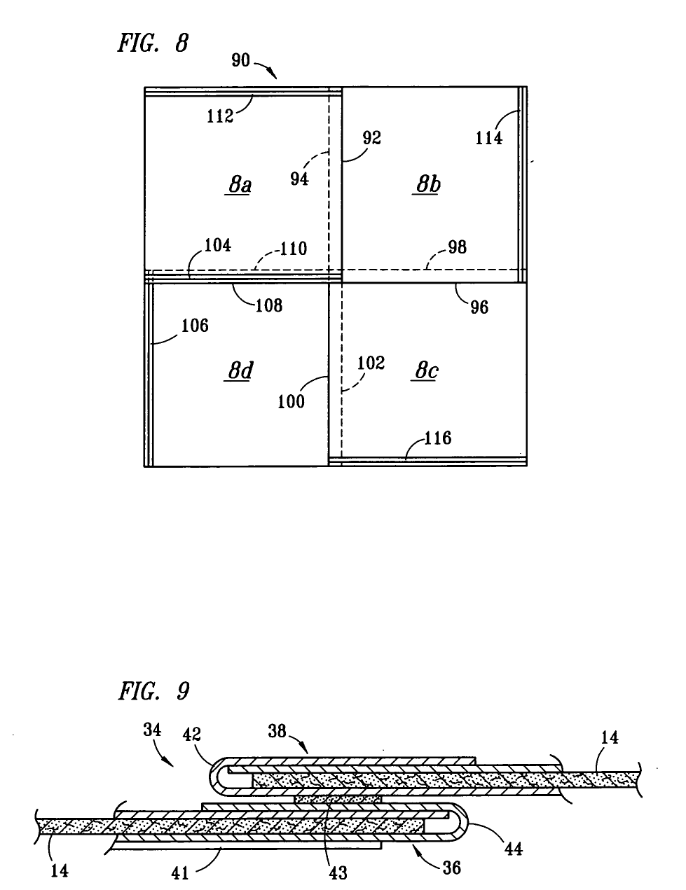

FIG. 8 depicts a bottom plan view of a composite pet housetraining pad 90 comprising four substantially square pet training pads 8a, 8b, 8c, 8d made as described above in relation to training pad 10. As viewed from the bottom, training pads 8a, 8b, 8c, 8d are aligned and releasably connected in a substantially square array, with pads 8b, 8d being rotated 90 degrees relative to pads 8a, 8c so that edge 94 of pad 8b lies above pad 8a and overlaps edge 92 of pad 8a, thereby permitting one adhesive strip (not visible) of pad 8b to be releasably attached to an adjacent portion of the upwardly facing surface of pad 8a. Similarly, edge 98 of pad 8c lies above pad 8b and overlaps edge 96 of pad 8b, thereby permitting one adhesive strip (not visible) of pad 8c to be releasably attached to an adjacent portion of the upwardly facing surface of pad 8b. Similarly, edge 102 of pad 8d lies above pad 8c and overlaps edge 100 of pad 8c. Similarly, edge 110 of pad 8d lies above pad 8a and overlaps edge 108 of pad 8a. When training pads 8a, 8b, 8c, 8d are oriented and attached to each other in the configuration shown in FIG. 8, adhesive strips 104, 112 of pad 8a, adhesive strip 114 of pad 8b, adhesive strip 116 of pad 8c, and adhesive strip 106 of pad 8d can still be used to releasably attach composite pad 90 to an underlying support surface.

Referring again to FIGS. 1, 2, 4 and 9, moisture absorbing filler material 14 of training pad 10 is preferably treated with or comprises a minor amount of an attractant component that is effective for promoting use of the subject training pad for urination by pets, especially young dogs. The attractant can, for example, be sprayed onto filler material 14 or top sheet 28 during manufacture of pad 10 or incorporated into filler material 14 as a particulate component if desired. Various natural and synthetic scents known to those of skill in the art, some of which are disclosed above, can be used as the attractant component. Formulations of various compositions considered for use as attractants are published in the appendix of an article titled “Evaluating Odour Attractants for Control of Wild Dogs,” Wildlife Research, 1992, 19, 211-19. A preferred formulation selected from those presented is as follows:
418 ml caproic acid
351 ml butyric acid
   71 ml hexyl amine
   72 ml trimethyl amine
      6 ml dimethyl disulfide
      2 ml 2-mercaptoethanol
   90 ml ethyl caproate
      Other attractants not identified in the article that can be used in training pads 10 of the invention include, for example, p-cresyl acetate and phenyl acetic acid.

Training pad 10 can further comprise a minor amount of a composition distasteful to animals that will effectively discourage a pet, particularly a puppy, from chewing on the pad. One such composition is a bitter-tasting compound, denatonium benzoate, marketed under the trademark BITREX by Macfarlan Smith Limited. Another compound for possible use in this capacity is glyceryl-mono-laurate. The chew-deterrent composition will desirably not have a scent or odor that will also deter the animal from approaching training pad 10 for urination or elimination. Depending upon the material used, the chew-deterrent composition can, for example, be incorporated into training pad 10 in dry or powder form, or can be applied to the pad as a liquid by spraying or rolling, or by another similarly effective method.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventors are legally entitled.

We claim:

1. A multifunctional, disposable animal training pad useful for housebreaking canines, the pad having a moisture absorbing filler material captured between a moisture permeable top sheet and a moisture impermeable bottom sheet, the pad comprising at least two oppositely disposed edges and two downwardly facing parallel strips of releasable adhesive, one strip being located on the bottom sheet proximally to each of the two oppositely disposed edges.

2. The training pad of claim 1, further comprising an animal attractant composition.

3. The training pad of claim 1, further comprising a chew-deterrent composition.

4. The training pad of claim 2, further comprising a chew-deterrent composition.

5. The training pad of claim 1 wherein the two strips of releasable adhesive have an equal width.

6. The training pad of claim 5 wherein each strip is spaced inwardly from one of said edges by a distance approximately equal to said width.

7. The training pad of claim 1 wherein the pad is rectangular.

8. The training pad of claim 7 wherein the pad is substantially square.

9. The pad of claim 1 wherein each strip of releasable adhesive is covered by a peel-away cover strip that is wider than the strip of releasable adhesive.

10. An array comprising a plurality of training pads of claim 1, each training pad being releasably attached to at least one other training pad by one of said strips of releasable adhesive.

11. The array of claim 10 wherein a plurality of adhesive strips are releasably attachable to an underlying support surface.

12. The array of claim 10 wherein at least one adhesive strip of each pad is releasably attachable to an underlying support surface.

13. The array of claim 11 wherein the underlying support surface is a floor.
